(19) United States
(12) Patent Application Publication
(10) Pub. No.: US 2003/0067399 A1
(43) Pub. Date: Apr. 10, 2003

(54) Smart traffic services platform

(76) Inventor: Brian V. Wesley, Victoria (CA)

Correspondence Address: Robert A. Jensen, JENSEN & PUNTIGAM, P.S., 1020 United Airlines Bldg., 2033 Sixth Avenue, Seattlle, WA, 98121-2584, US

(21) Appl. No.: 09/972,128

(22) Filed: Oct. 4, 2001

(51) Int. Cl. G08G 1/095

(52) U.S. Cl. 340/907; 340/908; 340/815.4

(57) ABSTRACT

A microcomputer-controlled traffic sign, wherein a secure container is secured to the sign without obscuring the intended purpose and includes a selectively operable light source to enhance the visibility of the sign. The light source may be automatic or activated by an external source, such as an approaching automobile. The self-contained device may be used in conjunction with other traffic related devices and could include transmission or audible enhancements.

### TECHNICAL FIELD

This invention deals with a traffic information sharing and generating platform, which is a stand-alone platform for traffic-related functions and, more particularly, it is a platform which is utilized in conjunction with a standard traffic sign to, among other things, enhance the visibility and awareness of the sign, thereby rendering the sign far more effective in performing its intended function.

### BACKGROUND OF THE INVENTION

Since at least as early the introduction of motorized transportation, it has been recognized that some form of regulation is necessary to avoid accidents with other vehicles or with pedestrians. Although it is generally recognized that traffic signals accompanied with a light are more effective than without, there are certainly far more unlighted traffic signals than there are lighted ones, and therefore, an increased risk of accidents, either through negligence, or alternatively, just the inability to detect the sign for any one of a number of reasons, including the visual noise and/or background. With this in mind there have been several attempts to increase the visibility of vehicle signs through the introduction of some light source.

International Patent Application PCT/US99/15946 teaches the enhancement of visibility of a sign such as a stop sign by introducing at least one light-emitting diode upon the structure.

U.S. Pat. No. DES 351807 granted to Smith Oct. 25, 1994 discloses a design for an illuminated hand-held stop sign.

U.S. Pat. No. DES 423391, granted to Hansen Apr. 25, 2000, discloses a design for a hand-held traffic control sign with lights.

U.S. Pat. No. 5,276,424, granted to Hegemann Jan. 4, 1994, discloses a hand-held stop sign that could certainly be used with other traffic control signs, wherein the front and the back of the sign are spaced and contain light-emitting sources which can be seen through both faces of the sign.

U.S. Pat. No. 5,819,455 granted to Tsuda Oct. 13, 1998, discloses a sign including a light-emitting portion, which is powered by a solar-charged battery.

U.S. Pat. No. 5,974,712, granted to Kallionp\ddot{aa} Nov. 2, 1999, discloses a traffic sign, including curved surfaces which house a light source, which emits through the surface of the sign, displaying the intended message.

U.S. Pat. No. 6,031,468, granted to Tsao et al Feb. 29, 2000, discloses a warning light adapted to be slipped over the upper surface of a traffic control sign, such as a stop sign.

U.S. Pat. No. 6,035,567, granted to Cameron Mar. 14, 2000, discloses a hand-held hazard warning sign, which includes a sign plate displaying a warning message and at least one flashing light and horn for generating visible and audible signals.

U.S. Pat. No. 6,134,820, granted to Martinez, Oct. 24, 2000, discloses a hand-held, wafer-like signal, which includes a battery powered light at the upper portion thereof.

U.S. Pat. No. 6,150,957, granted to Henz et al Nov. 21, 2000, discloses a lighted sign and warning device, including a strobe light to attract attention.

U.S. Pat. No. 6,239,691 B1, granted to Preisler May 29, 2001, discloses a flashing light assembly for use on a portable traffic control safety sign.

### SUMMARY OF THE INVENTION

With the above-noted prior art in mind, it is an object of the present invention to provide a self-contained platform for substantially enhancing the function of a traffic sign, wherein the platform is secured to an existing traffic sign without major modification and without defeating or distracting from the intended purpose of the sign.

It is yet another object of the present invention to provide a traffic sign enhancement device, which may be quickly and easily installed upon an existing traffic sign by persons of minimal skill.

It is still another object of the present invention to provide a means for enhancing a traffic sign, which is relatively inexpensive, long-lasting and capable of being expanded to perform functions well beyond the primary purpose of enhancing the abilities of the traffic sign.

### BRIEF DESCRIPTION OF THE DRAWINGS

FIG. 1 illustrates a standard six-sided stop sign, having the inventive platform mounted to the upper portion thereof.

FIG. 2 is a portable traffic control sign such as used along construction sites, having the inventive platform mounted thereto.

FIG. 3 is an isometric enlarged view of the present inventive platform.

FIG. 4 is a block diagram showing the unit as used on a hand-held traffic sign.

FIG. 5 is a block diagram of a permanent traffic platform.

FIG. 6 is a block diagram of a platform as mounted to a permanent traffic sign.

FIG. 7 is a block diagram of the functions of a traffic platform on a temporary traffic sign.

FIG. 8 is a block diagram of the smart traffic service platform in car vehicle receiver.

### BEST MODE FOR CARRYING OUT THE INVENTION

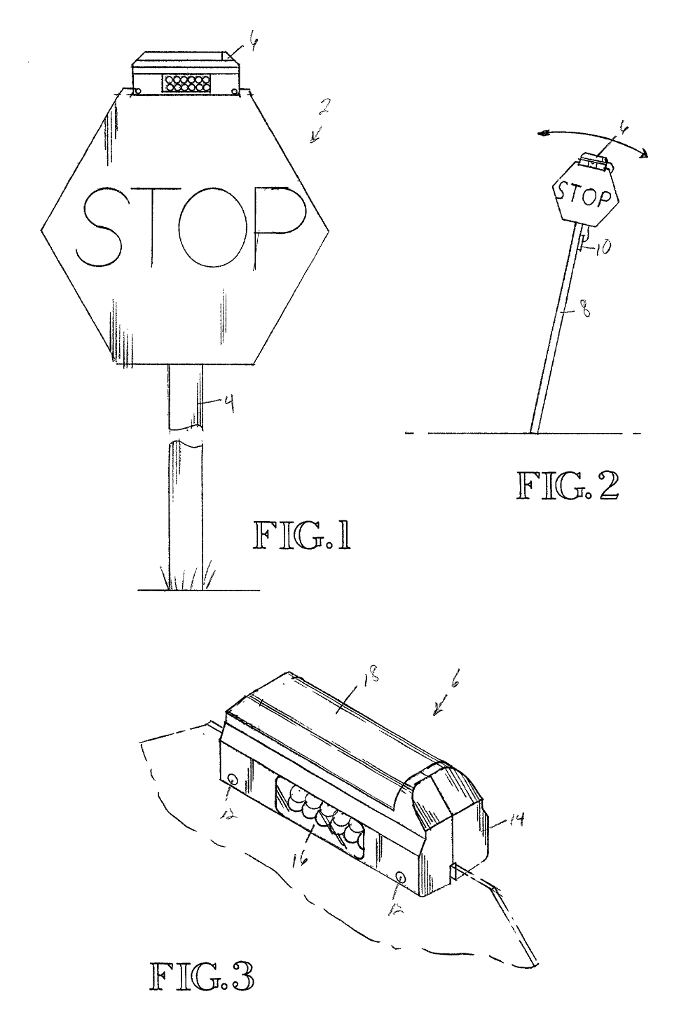

As seen in FIG. 1, a standard stop sign 2 is shown mounted to a vertical post 4 and mounted thereupon is the inventive sign enhancer and traffic platform 6, as will be described in greater detail hereinafter.

FIG. 2 is an illustration of the identical enhancer 6 mounted to a temporary traffic control device on a movable pole 8. Likewise shown in this view is a manual control switch 10, which enables the operator to energize the platform as needed.

Referring now to FIG. 3, it can be seen that the platform 6 is mounted to the upper portion of a stop sign (in phantom) and would be secured in place by a pair of fasteners not shown, but inserted in the openings 12, passing through the upper portions of the sign. It is to be understood that the fasteners would include non-standard securement means to inhibit the unauthorized removal of the device.

As currently envisioned, the traffic platform would not be limited to use on stop signs as illustrated, but could equally well be adapted by a change in configuration for use in conjunction with any traffic control sign, including railroad crossings, cross walks or the like. As illustrated in this view, the main body portion 14 would be weather proof and include, along with the necessary electronics, a transparent window 16, exposing to view a plurality of light sources, which could be light-emitting diodes which could flash intermittently, could flash in a pattern and, as explained hereinafter, could be selectively activated or deactivated. The upper portion 18 of the housing would be removable to expose the power source which as currently envisioned would include a plurality of rechargeable batteries which would be electrically connected to a solar panel for assurance of readiness at all times.

Specific, utilitarian applications will be described hereinafter. It is to be understood that the device is designed to house additional capabilities by serving as an installation platform to house optional third party devices and services related to traffic management and control. Since the device is located at the top of a traffic sign, it has a strategic location and not only provides a physical location for installing other devices and services, but also provides such critical elements as power, security, control and maintenance in an all-weather enclosed environment.

It is to be understood that these devices and services may include the ability to conduct traffic counts, toll collection, vehicle identification, traffic surveillance, monitoring and enforcement of vehicles speed limit compliance, as well as vehicle and pedestrian proximity detection, enforcement of heavy vehicle restrictions and dangerous goods, transportation management and detection.

In order to provide the services, the housing must be made of highly durable material that is resistant to damage and weather. In the preferred embodiment, the device is completely self-contained and there are no external devices, wires or connections that could easily be damaged by weather or vandalism. The color and arrangement of the lights and/or their flashing sequence can easily be varied to accommodate the particular usage. The microcomputer base control circuit could vary the pattern of flashing. In one possible embodiment of the invention, the configuration of the LEDs, includes the ability to illuminate the surface of the sign, and obviously, the type of LED chosen and the type of lens used to enclose the device determines the dispersion of light emitted. The microcomputer circuit also includes a software controlled sensor that monitors the ambient light levels to automatically change the intensity of the LEDs to maximize visibility and includes software controlled motion detection system which serves as a vandalism deterrent, and could include an audible alarm in the event of vandalism, as well as disabling circuits, rendering the device useless.

It is to be understood that the microcomputer circuit also would conduct a system check each time the device was activated and indicate if maintenance or replacement was required. The microcomputer would likewise monitor and manage the available power and lessen the power over to the LEDS to prevent a total shutdown.

It is to be understood that one embodiment of the invention includes a transmitter module that is capable of sending a signal to a remote receiver in a vehicle to give advance warning of the approach to the sign, or to transmit static or real-time information to the vehicle, and could also include a real-time clock, wherein the device is activated during a specific time of day or days of the week, automatically, and could include a sleep function which minimizes the activity when no traffic is present but would detect the approach of oncoming traffic by means of infrared, motion or light sensors to fully activate the device to warn the approaching vehicle.

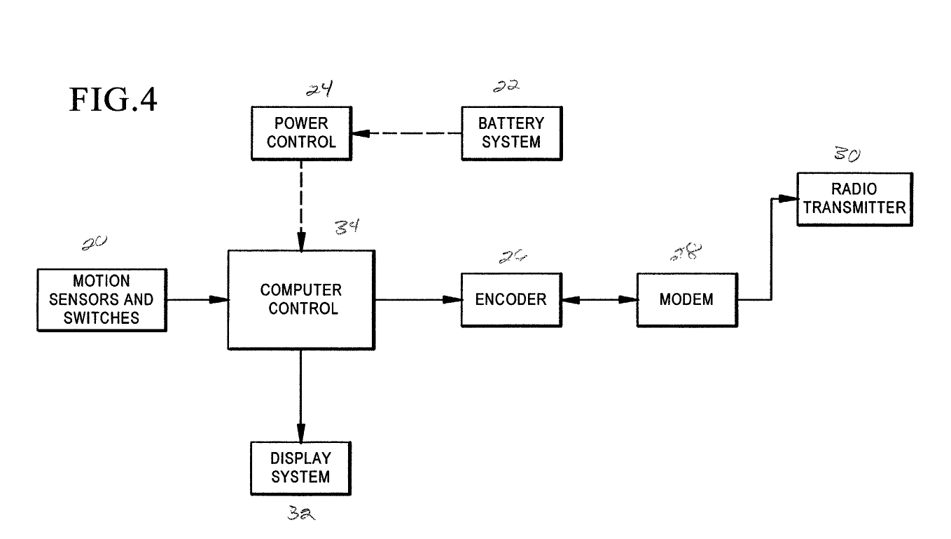

Reference is now had to FIG. 4, which is the operating system for a hand-held traffic sign and includes a motion sensor and switch 20, which allows the operator to control the sign. The motion sensors 20 detect the orientation of the sign and turn the flashing signals on and off depending on what relative position the sign in being held in, i.e., on when the sign is upright and off when it is in some position other than upright. The battery system 22, which provides the DC power to operate the sign, feeds through a power control 24, which converts the unregulated battery voltage to regulated voltage to run the computer control 34 and display system 32. An encoder box 26 provides a digital message for delivery to the modem, which converts the digital output to an analog signal that can be used to power the radio transmitter 30, which converts the low level analog signal from the modem to an FRO signal of sufficient power to allow a radio receiver device to correctly receive the message.

Probably most critical, display system 32 provides a visual display to the vehicle operators, using an array of light-emitting diodes, which are controlled by the computer control system 34, wherein the intensity of the LEDs is controlled by monitoring the ambient light conditions. The visual displays are programmed to flash in a distinctive pattern to optimize the ability to attract the attention of an approaching driver. The computer control system processes data from all sensor and switch inputs and controls power to the radio transmitter and display system. The computer control system executes instructions stored in the program memory of the microcomputer to operate the sign.

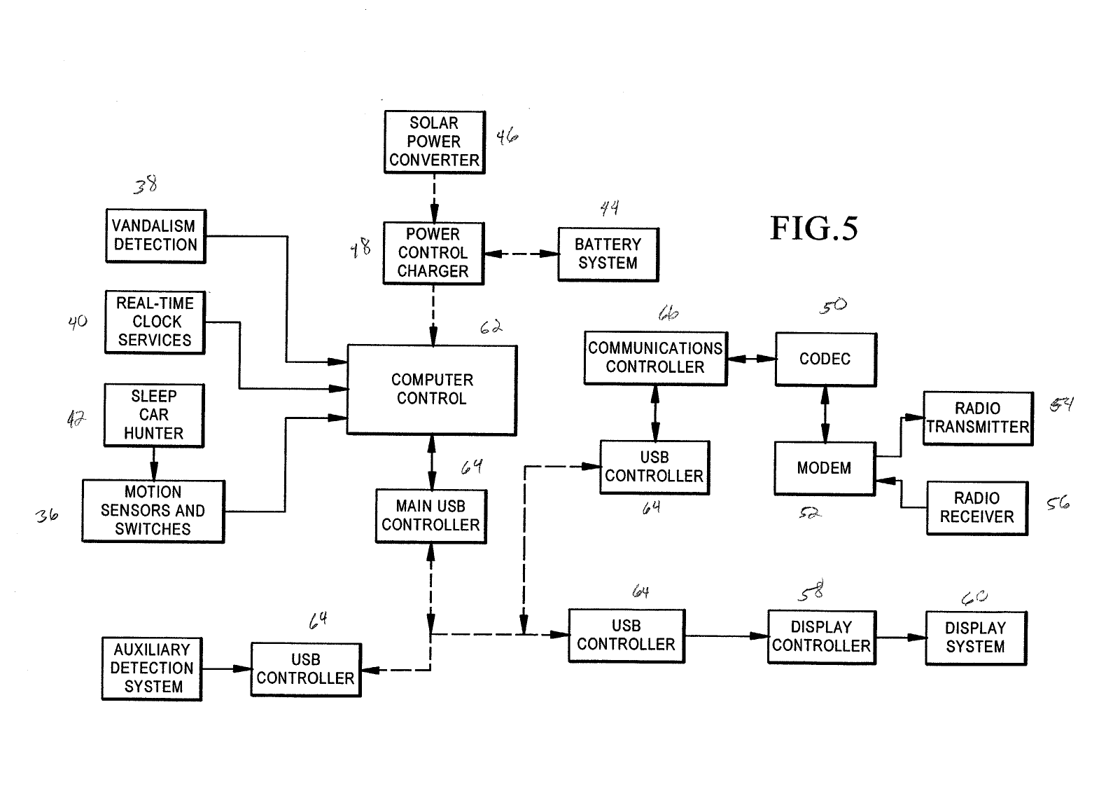

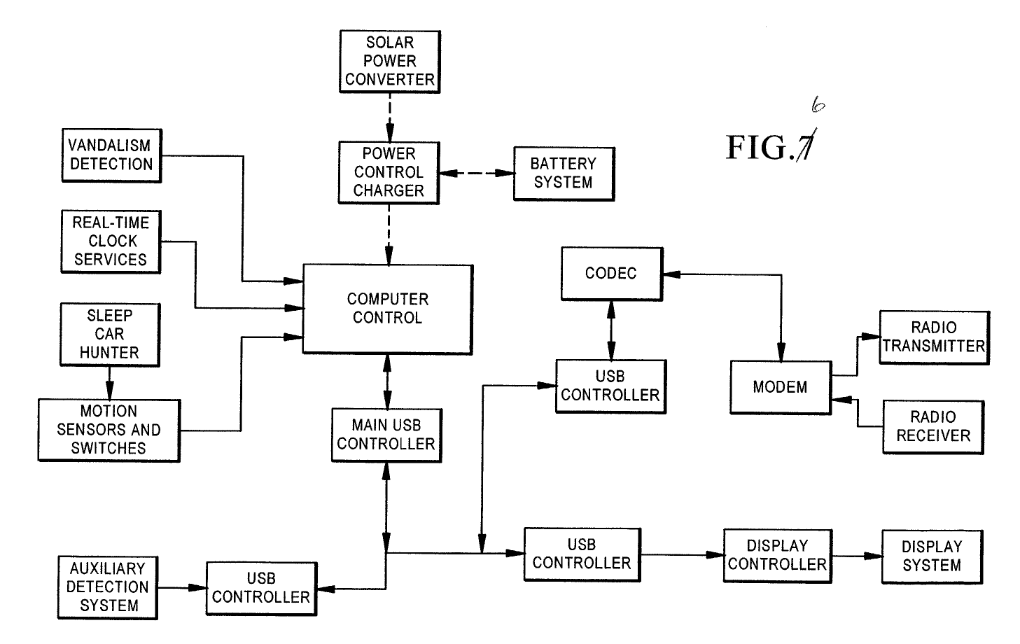

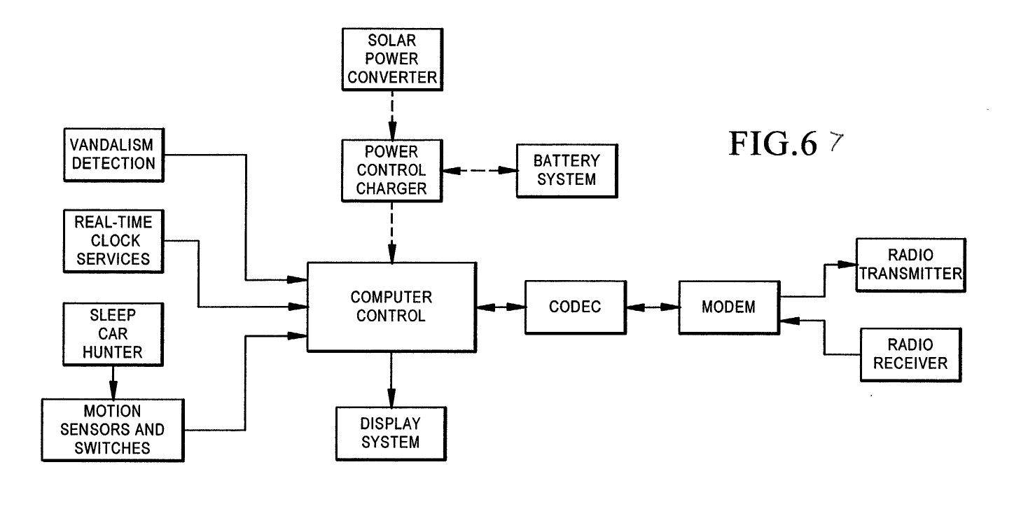

FIGS. 5 and 6 will be considered together since they contain more similarities than differences. The motion sensors and switches 36 include sensors to provide the traffic sign needed to allow the operator to control the sign, as well detect the orientation of the sign and turn the flashing signals on or off depending upon what manner the sign is being mounted. The switches control power on and power off functions. The data provided by these sensors and switches is sent to the computer control system for processing. The vandalism detection 38 used in the permanent traffic signs warns of potential tampering and shuts down the sign from further use. The sign display will not operate until the radio receiver receives a special code, which could put the sign into a transponder mode to allow it to be tracked down from a remote location.

The real-time clock circuit services 40 system allows the sign to operate during specific times of the day and night without external signaling and includes a provision wherein it can be remotely programmed for delayed operation and power conservation. The sleep mode car hunter sensors 42 allow the traffic sign to go in to an inactive or sleep state until a vehicle approaches the sign. The car hunter function operates at a specific threshold determined by the sign operator to improve repeatability among different signs. The battery system 44 in the permanent traffic signs is a rechargeable type that stores power from the solar power converter 46, charging the system during daylight hours for use at night. Both the battery system and the solar power converter feed through the power control charger 48, which provides polarity protection for the sign's electronics and converts the unregulated battery voltage to a regulated voltage to run the computer control and display systems. The power control also regulates the charging of the rechargeable batteries from the solar power converter to maximize the battery operating life for power storage capacity. In addition, the power control can be turned off and on either by computer directly or by a push button switch. The codec (coder-decoder) 50 provides both message and coding for delivery to the modem and a message decoder for data coming from the modem. The encoding system improves the chances for reception of a signal from the receiver by adding redundant data to the message. The message is also tagged with a unique code to prevent other messages not meant for the receiver from being processed. The decoder section of codec 50 receives data from the modem and strips off redundant data bits and message addresses to deliver the message to the computer control system 62. The modem 52 converts the digital output of the encoder to an analog signal that can be used by the radio transmitter 54 to process information on the radio frequency carrier's signal. It also receives an analog signal from the radio receiver 56 and converts it to a digital signal for processing by the codec. The radio transmitter 54 receives a low-level analog signal from a radio transmitter from another device, amplifies and translates it down to a lower frequency to deliver a base band analog of sufficient amplitude to the modem for processing. The radio receiver also filters out adjacent signals from other devices to isolate the frequency at which the signal is set. The radio transmitter 54 converts the low level analog signal from the modem to an RF signal of sufficient power and appropriate frequency to allow the radio receiver devices located on other traffic signs or traffic control devices or devices located on or within approaching vehicles to correctly receive the message sent from the sign. The transmitter also contains a small antenna that converts the RF signal to electromagnetic waves, which propagate from the sign. The display controller 58 and display system 60 work together in that the controller controls the display system, and it is to be understood that this model is a dedicated computer system that can operate more than a single display system as required. This ability allows for a variable message sign with a small form factor for lane control systems by displaying an array of light-emitting diodes. The intensity of the LEDs is controlled by monitoring the ambient light condition with a photosensitive detector located on the display boards.

The computer control 62 processes the data from all sensors, switches, clock inputs and controls powered to the radio transmitter, receiver and display system. The computer control system executes the instructions stored in the program memory of the microcomputer to operate the sign. One embodiment of the device includes the ability to reprogram systems and functions by means of a wireless infrared or optical input. The computer control system communicates with the different subsystems of the sign via the USB high speed serial bus 64.

The USB controllers 64 provide for the increased modularity of the sign system. The inclusion of these devices allows different devices, even those from third party companies, to be used within the sign system. The USB system also specifies power control system integration and automatic recognition of new devices. The modular nature of the sign system will also extend its useful operating life by allowing the addition of enhanced vehicle and pedestrian detectors and communication systems as they become available. The data rate of the USB system can provide real-time video surveillance capabilities for traffic management and control and other operations. The USB will also allow different types of wireless services to be employed as they become cost effective with this type of application.

The communications controller 66, which is a part of the device of FIG. 5 that, as seen is not necessary in FIG. 7, allows the traffic sign to process a wider variety of messages and communication protocols. This controller will permit remote programming of the sign's operation and relaying of messages to other devices using different protocols. This permits the networking of different devices using the wireless radio transceivers.

The block diagram as shown in FIG. 7 is for use with respect to a temporary traffic sign and includes many of the same elements in common with the disclosure of FIGS. 5 and 6, and therefore, will not be described in detail.

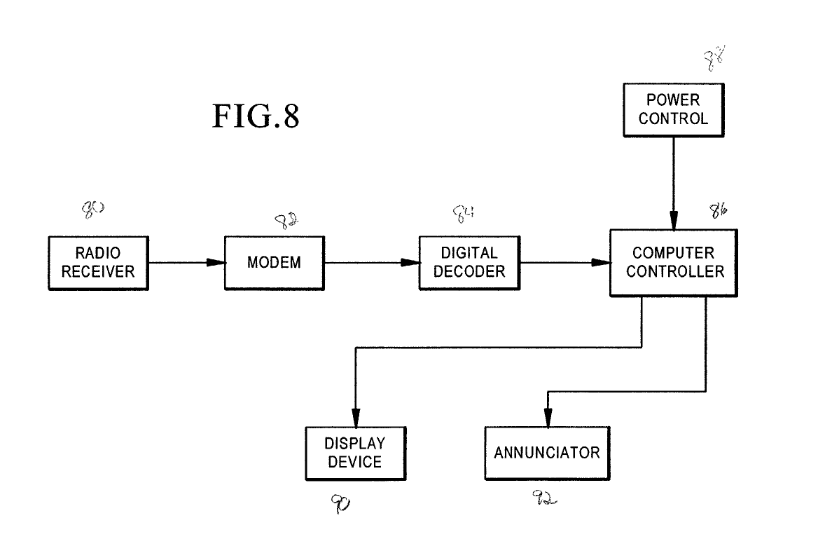

FIG. 8 discloses the in-car vehicle receiver, which includes a radio receiver 80, which feeds to a modem 82, converting the signal through a digital decoder 84 to computer controller 86, which is sourced by the power control 88, which would be the automobile's electrical system. The computer controller can drive either a display device 90 or an enunciator 92 which can give then audible warning. The capabilities of the in-car receiver may also be re-purposed to serve as a personal receiving device for use by pedestrians.

Thus, as can be seen, the present invention provides a unique powerful system which can be incorporated into traffic signs to not only make them far more visible and effective, but also to augment and extend their capabilities by using the strategic location of the device mounted on the traffic sign and the sensing, monitoring and communication capabilities of the device to offer new and enhanced services designed to manage, control and inform drivers, pedestrians and vehicles.

1) A shared multi-functional microcomputer-controlled service platform for use in conjunction with a traffic sign, wherein the platform is self-contained, and its use does not obscure or require modification of the sign, comprising:
a tamper-resistant outer case adapted to be secured to the periphery of the sign without obscuring the sign;
an internal, standards based, flexible mounting platform to accommodate the installation energizing, maintenance, management and control of other devices and services related to traffic management, information and communications services;
a plurality of selectively activated lights mounted within the case and visible a substantial distance from the case; and
transmitting/receiving means mounted within the case capable of communicating with an appropriately equipped vehicle or other related devices and services.

2) A microcomputer-controlled traffic sign enhancement device comprising:
a secure container adapted to receive the upper portion of the sign without obscuring the sign and to be secured thereto;
a self-contained power source;
selectively operable light means within the container, visible a substantial distance from the sign; and
detector means capable of detecting the presence of a vehicle or person and activating the lights.

3) A traffic sign as in claim 1, and further including:
an audible alarm system within the device that activates upon movement of the sign above a threshold level and renders the device inoperable.

4) A traffic sign as in claim 1, and further including:
a radio transmitter and receiver capable of communicating with other traffic signs or related devices, in-car information, control and alarm devices.

5) A traffic sign as in claim 1, and further including:
a means whereby changes, maintenance, diagnostics, control and updates can be made by means of a communications interface.
